(19) United States
(12) Patent Application Publication
(10) Pub. No.: US 2019/0080807 A1
(43) Pub. Date: Mar. 14, 2019

(54) Apparatus and System for Radiation Protection and Thermal Insulation

(71) Applicant: American Ceramic Technology, Inc., Anderson, SC (US)

(72) Inventors: Jerrald Scott McCall, Six Mile, SC (US); Virgil Irick, Anderson, SC (US); Richard Culbertson, Poway, CA (US)

(21) Appl. No.: 15/704,738

(22) Filed: Sep. 14, 2017

(51) Int. Cl. G21F 1/12; H01F 1/053; G21F 3/00

(52) U.S. Cl. CPC G21F 1/125; G21F 3/00; H01F 1/053

(57) ABSTRACT

An apparatus and method for shielding against radiation and providing thermal insulation is disclosed. The apparatus includes multiple layers including an inner layer, an outer layer, and a radiation shielding layer composed of materials such a tungsten sheet, multiple tungsten sheets, staggered rows of tungsten rods, and/or a polymer radiation shield composed of a polymer and radiation attenuating material. Insulation layers may also be incorporated into the apparatus. The method for protecting against radiation includes the steps of providing a radiation shielding apparatus and securing such apparatus to a radiation emitting structure.

### BACKGROUND

The present invention relates generally to an apparatus and method for protecting against radiation and providing insulation. More particularly, the invention relates to an apparatus and method for providing thermal insulation, such as through use of reflective metal insulation and/or other insulating materials, and for providing radiation protection using at least one radiation shielding layer.

Nuclear power plants and other radiation containing facilities often release a wide spectrum of radiation. For example, dangerous gamma radiation may be released from sources such as isotopes of the metals including cobalt and cesium. The radiation is often emitted through pipes positioned throughout the nuclear facilities. These pipes are typically stainless steel pipes containing superheated water. In many nuclear facilities, the superheated water is 600 degrees Fahrenheit and above. Dangerous radioactive isotopes shed by nuclear reactor fuel often exists in the superheated water and therefore move throughout the nuclear facility within the pipes. The isotopes also frequently settle into the elbows, tees, junctions, etc. of the pipes.

Without some form of shielding, high levels of radiation, such as neutron radiation and/or gamma radiation, may be exuded from these pipes. Further, these pipes often cause significant increases in the surrounding ambient temperature because of the high temperatures running through the pipes. To minimize radiation exposure as well as provide a more pleasant work environment, a variety of temporary and permanent devices and systems have been used to shield against the radiation and reduce thermal loss of the water. Many of these devices and systems however are cumbersome, ineffective, and/or have their own environmental disadvantages.

Thus, while some devices and systems are known, there is a need for an effective, lightweight, and easy to install apparatus and method for protecting and shielding against harmful radiation while also providing thermal insulation to control and limit heat loss to the surrounding ambient.

### SUMMARY

The present invention includes a radiation shielding insulation apparatus. In one embodiment of the apparatus, the apparatus includes an inner layer, a radiation shielding layer adjacent to the inner layer, and an outer layer. In this embodiment, the radiation shielding layer is composed of tungsten, which may be in the form of a tungsten sheet, multiple tungsten sheets, or rows of staggered tungsten rods. Insulation layers may also be incorporated, such as reflective metal insulation layers having pockets therebetween.

In an alternative embodiment of the radiation shielding insulation apparatus, the apparatus includes an inner layer, a radiation shielding layer, an intermediate layer, an insulation layer, and an outer layer. The radiation shielding layer is positioned adjacent to the inner layer and the intermediate layer is positioned adjacent to the radiation shielding layer. Further, in this embodiment, the insulation layer is positioned between the intermediate layer and the outer layer. In this embodiment, the radiation shielding layer may be composed of tungsten, such as in the form of a tungsten sheet, multiple tungsten sheets, or rows of staggered tungsten rods. The insulation layer may include one or more reflective metal insulation layers having pockets therebetween. Alternatively, the insulation layer may include diatomaceous earth or a combination of reflective metal insulation layer(s) and diatomaceous earth. The inner, outer, and intermediate layers may be composed of reflective metal, such as stainless steel.

In yet another embodiment of the radiation shielding insulation apparatus, the apparatus includes an inner layer, an insulation layer, an intermediate layer, a radiation shielding layer, and an outer layer. In this embodiment, the insulation layer is positioned between the inner layer and the intermediate layer and the radiation shielding layer is positioned between the intermediate layer and the outer layer. The insulation layer may include one or more reflective metal insulation layers having pockets therebetween. Alternatively, the insulation layer may include diatomaceous earth or a combination of reflective metal insulation layer(s) and diatomaceous earth. The inner, outer, and intermediate layers may be composed of reflective metal, such as stainless steel. The radiation shielding layer may include a polymer radiation shield incorporating a polymer, such as silicone, and a radiation attenuating material such as iron, tungsten, bismuth, lead, boron carbide, aluminum trihydrate, gadolinium oxide, or combinations thereof. Further, the polymer radiation shield may incorporate a magnetic material, such as a rare-earth alloy. The radiation attenuating material and/or the magnetic material may be dispersed within the polymer. In this embodiment, additional insulation layers may be positioned between the radiation shielding layer and the outer layer.

The present invention also includes a method for protecting against radiation and providing thermal insulation. The method includes the steps of providing a radiation shielding insulation apparatus, such as those disclosed above and herein, and securing the apparatus to a radiation emitting structure. Alternatively, the method includes the steps of providing an apparatus having an inner layer, an outer layer, and reflective metal insulation layers therebetween, securing said apparatus to a structure for emitting radiation, and then securing a radiation shielding layer to said apparatus after said apparatus is secured to said structure for emitting radiation.

### BRIEF DESCRIPTION OF THE DRAWINGS

FIG. 1 is a perspective view of an embodiment of a radiation shielding insulation apparatus of the present invention.

FIG. 2 is a schematic cross-sectional view of an embodiment of a segment of a radiation shielding insulation apparatus of the present invention.

FIG. 3 is a schematic cross-sectional view of an embodiment of a segment of a radiation shielding insulation apparatus of the present invention.

FIG. 4 is a schematic cross-sectional view of an embodiment of a segment of a radiation shielding insulation apparatus of the present invention.

FIG. 5 is a schematic cross-sectional view of an embodiment of a segment of a radiation shielding insulation apparatus of the present invention.

FIG. 6 is a schematic cross-sectional view of an embodiment of a segment of a radiation shielding insulation apparatus of the present invention.

FIG. 7 is a schematic cross-sectional view of an embodiment of a segment of a radiation shielding insulation apparatus of the present invention.

FIG. 8 is a schematic cross-sectional view of an embodiment of a segment of a radiation shielding insulation apparatus of the present invention.

FIG. 9 is a schematic cross-sectional view of an embodiment of a segment of a radiation shielding insulation apparatus of the present invention.

### DETAILED DESCRIPTION OF REPRESENTATIVE EMBODIMENTS

The present invention relates to an apparatus and method for shielding against radiation and providing thermal insulation. The radiation shielding and thermal insulation apparatus of the present invention preferably includes multiple material layers. The multiple materials layers preferably include at least an inner layer, an outer layer, and a radiation shielding layer. A single or multiple insulation layers may also be incorporated. The combination and properties of the material layers of the present invention preferably reduce radiation emanating from a device as well as reduce the amount of thermal energy loss from an object. Moreover, the structure of the apparatus of the present invention also preferably provides for easy and universal installation of the apparatus on most radiation emitting objects.

The composition, components, materials, sizes, and shapes of the shielding insulation apparatus may vary. For example, the apparatus may vary depending upon preferred radiation attenuating ability, preferred weight of the apparatus, the desired reduction in thermal energy, and/or the shape of the radiation emitting structure. Although primarily described herein in terms of its use to protect against harmful radiation and reduce thermal energy loss, it will be clear that the apparatus and method of the present invention may also provide other benefits. Further, the primary components of the shielding insulation apparatus as described herein may be combined with additional components and materials without departing from the spirit and the scope of the present invention. The invention will be described with reference to the figures which are an integral non-limiting component of the invention. Throughout the description similar elements will be numbered accordingly.

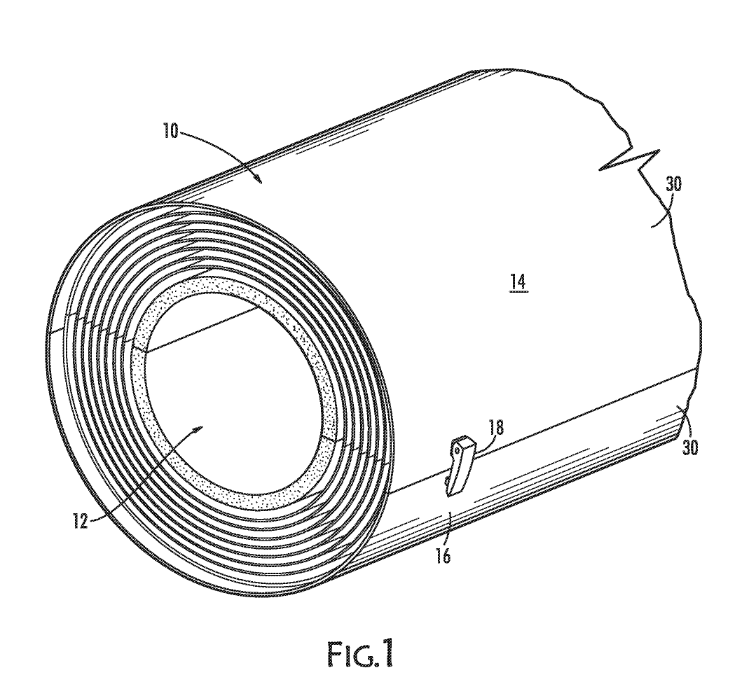

As discussed above, the shielding insulation apparatus of the present invention includes multiple material layers for radiation attenuation and/or thermal energy reduction. FIG. 1 discloses an embodiment of a shielding insulation apparatus 10 of the present invention. In the embodiment of FIG. 1, the combined layers form a cylinder with an opening 12 extending therethrough. The apparatus 10 of FIG. 1 includes a first segment 14 and a second segment 16 that may be secured together by connectors such as by latch 18. While two segments are shown in FIG. 1, a single segment or multiple segments may be used to create the apparatus of the present invention. Multiple small segments may be particularly beneficial for easier installation at most locations around an object. Moreover, smaller lighter-weight entirely separable segments may be preferred because the strength needed to lift a smaller segment during installation is often significantly less than the strength needed to lift multiple combined segments thereby making installation easier.

The design of the radiation shielding insulation apparatus shown in FIG. 1, is particularly suitable for use in securing around the outside of a cylindrical pipe structure. It may be preferred, but not required, that the shielding insulation apparatus of the present invention completely surround a radiation emitting structure. Alternatively however, some pipes may be positioned within a facility such as against a wall so that only a portion of the radiation emitting structure is exposed to individuals within the facility. In this case, the shielding insulation apparatus may only need to partially cover the radiation emitting structure.

As discussed above, the embodiment of FIG. 1 includes a first and a second segment 14, 16, respectively. In this embodiment, the first and second segments 14, 16 each form an arc shape. One or more latches, such as latch 18, may be incorporated on the external surface of the outer layer of the apparatus to secure the two segments 14, 16 together and thereby completely enclose a pipe structure. Alternatively, the multiple apparatuses and/or multiple segments may be combined using a snap configuration.

Multiple segments may be combined along the length of a radiation emitting structure due to the weight and potential installation difficulty associated with a reflective metal insulation apparatus extending the entire length of a radiation emitting structure. The outer layer 30 of the shielding insulation apparatus may include overlapping or overhanging layers to remove potential seams, openings, etc. caused by the use of multiple segments extending along the radiation emitting structure. This is particularly useful in protecting against gamma radiation, which travels in straight lines from its source and therefore can be sufficiently shielded when all openings, cracks, holes, seams, and joints are effectively sealed off with radiation shielding material.

It will be understood to those of skill in the art that radiation emitting sources and structures have various shapes, contours, and sizes. For example, a radiation emitting structure may have a cylindrical, square, rectangular, or octagonal shape. Thus, the apparatus of the present invention may likewise conform to such shapes, contours, and sizes without departing from the spirit and scope of the present invention. Indeed, the ability to easily modify the shape of the apparatus is a particular advantage of most embodiments of the present invention. The internal diameter of the opening 12 of the shielding insulation apparatus 10 is preferably slightly greater than the outer diameter of the radiation emitting structure. Thus, as an example, cylindrical stainless steel piping within nuclear facilities is often between 0.5 and 36 inches in diameter. Thus the opening 12 of the shielding insulation apparatus 10 is preferably slightly larger than the outer diameter of the piping. For example, the opening 12 of the radiation shielding insulation apparatus 10 may be 0.6 to 40 inches in diameter to secure around a 0.5 to 36 inch cylindrical piping.

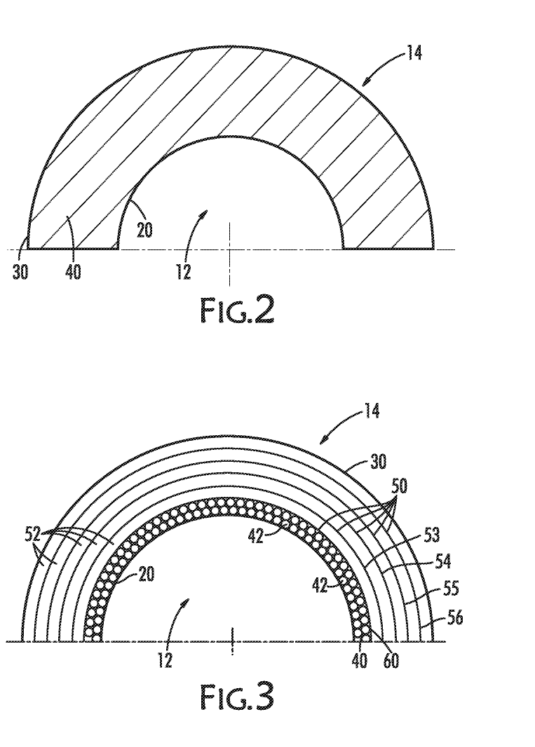

FIG. 2 discloses an arc shaped segment, such as first segment 14, according to an embodiment of the apparatus 10 of the present invention. The first segment 14 of FIG. 2 includes three layers. Specifically, the segment 14 includes an inner layer 20, a radiation shielding layer 40, and an outer layer 30.

The inner layer 20 is the layer that is nearest to or adjacent to the radiation emitting object. The inner layer 20 provides structural support for the apparatus 10 around the radiation emitting object and is therefore composed of a suitable material capable of providing such support that does not otherwise degrade the functional integrity of the apparatus. Further, because the inner layer 20 is nearest to the radiation emitting object, which often also emits high temperatures, a high heat tolerant material, such as reflective metals, are particularly preferred for use as the inner layer 20. For example, steel, such as stainless steel, is a particularly suitable reflective metal and supporting material for use as the inner layer. For example, 16 to 28 gauge stainless steel may be used as the inner layer 20. Alternatively, the inner layer 20 may be comprised of tungsten such as a tungsten metal sheet, which provides radiation shielding benefits directly adjacent to the radiation emitting source.

The outer layer 30, like the inner layer 20, provides structural support for the apparatus 10 and is therefore also composed of a suitable material capable of providing support to the apparatus, such as a reflective metal. Unlike the inner layer 20, the outer layer 30 is the layer furthest from the radiation emitting object and forms the external surface layer of the apparatus 10. Because the outer layer 30 is the furthest from the radiation and heat emitting source, the material of the outer layer 30 typically does not have to be as heat tolerant as the inner layer 20. In one embodiment, the inner layer 20 and the outer layer 30 are composed of the same material. Steel, such as stainless steel, is a particularly suitable supporting material for use as the outer layer 30. For example, 16 to 28 gauge stainless steel may be used as the outer layer.

In the embodiment of FIG. 2, the radiation shielding layer 40 separates the inner layer 20 and outer layer 30 of the segment 14. The radiation shielding layer 40 incorporates materials capable of attenuating or shielding against radiation. Metal materials are particularly useful at shielding against gamma, x-ray, and other forms of harmful radiation. Examples of attenuating metals include tungsten, lead, bismuth, iron, and combinations thereof. Ceramics and other materials, such as boron carbide, aluminum trihydrate, bismuth metal sheets, and gadolinium oxide powder (Gd₂O₃), are particularly useful at shielding against neutron radiation.

In one embodiment, the radiation shielding layer 40 includes a radiation shielding material sheet or sheets. For example, the radiation shielding layer 40 may be composed of a single tungsten sheet. In such an embodiment, the tungsten sheet may have a thickness of between approximately 0.1 to 0.3 inches. In a preferred embodiment, the tungsten sheet is approximately 0.16 to 0.17 inches thick. Alternatively, the radiation shielding layer 40 includes multiple tungsten sheets. For example, eight tungsten sheets may be incorporated wherein each sheet is approximately 0.02 inches in thickness. Preferably, the total thickness of the tungsten sheets is at least 0.16 inches in thickness, which reduces radiation, such as gamma radiation from Co-60, by approximately 50 percent. If additional radiation reduction is sought, additional tungsten sheets and/or thicker tungsten sheets may be incorporated to increase the total thickness of the radiation shielding layer to greater than 0.16 inches. Moreover, multiple sheets of various thicknesses may be combined to form the radiation shielding layer 40.

Alternatively, the radiation shielding layer 40 includes radiation shielding rods. For example, the radiation shielding layer 40 may be composed of a row or rows of tungsten rods. The rods may be various shapes and diameters, such as circular, oval, square, or rectangular, without departing from the spirit and scope of the present invention. Preferably at least two rows of staggered rods are incorporated to block the passage of radiation through the seam formed between the rods. In a particularly preferred embodiment, three rows of rods are used. In an embodiment using circular tungsten rods, the rods may have a diameter of approximately 0.1 to 0.5 inches. For example, the rods may have a diameter of approximately 0.25 to 0.3 inches so that two rows decrease the radiation attenuation by approximately 50 percent. Alternatively, multiple rod diameters may be combined to form the radiation shielding layer. In a further alternative embodiment, tungsten pellets or spheres may be used instead of or in addition to the traditional rod shape.

Radiation attenuation rods 42 are particularly useful in connection with the present invention since they can be arranged to accommodate an almost unlimited number of geometries, widths, and shapes. Indeed, rods 42 can be used for radiation shielding of complex geometries such as elbows, tees, and y-shaped configurations. For example, a simple box structure with square corners can be made in a fashion such that the ends of the elbow, or whatever shape used, protrude slightly from the sheet metal box for connection to the next section of pipe. The box can be single- or double-walled or made to include interior segments that are strategically placed inside the box to aid with positioning and spacing the shielding rods. Furthermore spherical shaped shielding material, such as metal spheres sized from approximately 10-15 millimeters in diameter, may be incorporated with the rods. Such spherical or near-spherical pourable shielding media made of W, Fe or other selected metals or ceramics can be simply poured in around an array of tungsten rods or used alone in some sections where inserting traditional shaped rods is difficult.

The segment of FIG. 2 may form a cassette, which has an inner and outer layer with radiation attenuating material, such as rods, that are independently secured to piping to form the apparatus of the present invention or is inserted into pockets, discussed below, between reflective metal insulation layers to form the apparatus of the present invention. Cassettes are particularly beneficial for inserting into an existing shielding and/or insulation apparatus to increase radiation attenuating ability therein.

In yet another alternative embodiment, the radiation shielding layer 40 includes a polymer radiation shield. A polymer radiation shield is typically composed of a polymer and a radiation attenuating material. The polymer radiation shield may also include a magnetic material such as the radiation shield disclosed in U.S. Pat. No. 9,666,317, which is incorporated herein by reference. As discussed in such application, the radiation shield may itself be constructed in independent layers and may include a single dispersed composite layer having all primary components or multiple layers having dispersed composite layers and/or distinct component layers. Incorporating a magnetic component may be particularly useful for nuclear radiation reduction as well as potential for securing to an outer layer or wall composed of magnetically adhering material such as steel. Further, the apparatus of the present invention may be held together using a polymer radiation shield incorporating magnetic material. For example, such magnetic polymer radiation shields may be secured around the apparatus of the present invention, may be incorporated to seal joints, seams, or elbows, and/or may be incorporated to magnetically lock portions of the apparatus together.

Example suitable polymers for the polymer radiation shield of the present invention include both natural rubbers and synthetic rubbers. The flexibility of synthetic rubbers, also known as elastomers, may make synthetic rubbers more preferred for certain applications. An example of a particularly preferable polymer is liquid silicone rubber, which may be heat cured or air cured. Heat cured liquid silicone rubbers may be preferable when the radiation shield must be manufactured under tight time constraints. Silicone rubbers that accept greater loads of attenuating and magnetic materials are also highly preferred. Such silicones typically have lower viscosities (e.g., 10,000 cps-25,000 cps), limited fillers (such as longer vinyl groups instead of shorter vinyl groups), and non-fumed silica. Example liquid silicone rubbers for use in the radiation shield of the present invention include polymethylvinylsiloxane and polydimethylsiloxane hydrogen terminated (hydrogen is terminated by using a silane for electron transport).

Suitable attenuating materials of the polymer radiation shield that may be incorporated into the present invention include metals that are particularly useful at shielding gamma, x-ray, and other forms of radiation, and/or ceramic materials, which are particularly useful at shielding neutron radiation. Examples of attenuating metals are those discussed above and include bismuth, lead, tungsten, and iron. Particularly preferred attenuating metals include tungsten, iron, and combinations thereof. Examples of neutron radiation attenuating materials are those discussed above and include boron carbide, aluminum trihydrate, bismuth metal sheets, and gadolinium oxide powder.

The particular radiation attenuating abilities, weight, and flexibility of a polymer radiation shield of the present invention may be adjusted to suit the particular application. Example compositions for polymer radiation shields that may be incorporated into the present invention are set forth in Table I below.

TABLE I
Metal Radiation Shield Compositions

| | | | |
|---|---|---|---|
| Material | Percent by volume | Thickness | % Attenuation |

Composition Example 1

| | | | |
|---|---|---|---|
| Iron Powder | 25-50% | 1.25 in | 50 |
| Silicone | 50-75% | | |

Composition Example 2

| | | | |
|---|---|---|---|
| Tungsten Powder | 20-55% | 0.5 in | 50 |
| Silicone | 45-80% | | |

Composition Example 3

| | | | |
|---|---|---|---|
| Boron Carbide Powder | 10-30% | 2.5 | 50-80 |
| Aluminum Trihydrate | 10-30% | | |
| Magnetic Powder | 0-35% | | |
| Silicone | 25-80% | | |

While example dimensions and compositions have been provided above, it will be understood that shielding levels of the present invention can be engineered to essentially any level as necessitated by an application.

As shown in FIG. 3, the segment 14 of the apparatus 10 of the present invention may also include one or more insulation layers 50. As more fully discussed below, insulation layers 50 are highly preferable when the radiation shielding layer 40 incorporates a polymer radiation shield. The insulation layers 50 control the temperature within the radiation shielding insulation apparatus and the ambient surrounding apparatus. Thus, the material, configuration, and position of the insulation layer(s) vary depending upon required heat reduction. For example, in the embodiment of FIG. 3, radiation attenuating rods 42, such as tungsten rods, are incorporated as the radiation shielding layer 40 and multiple reflective metal insulation layers 60, 53, 54, 55, 56 are positioned adjacent to the radiation shielding layer 40. Because tungsten is heat tolerant, insulation layers between the radiation attenuating rods 42 incorporating tungsten and the inner layer 20 are typically unnecessary. Furthermore, incorporating heat tolerant radiation attenuating rods 42 such as tungsten rods as close to the inner layer 20 as possible is often preferred because it reduces the material costs of the apparatus 10 as well as often reduces the weight of the apparatus 10. As stated above, the insulation layers 50 of FIG. 3 are reflective metal insulation layers 60, 53, 54, 55, 56, such as stainless steel layers forming pockets 52 or cavities of air therebetween. In this embodiment, five reflective metal insulation layers 60, 53, 54, 55, 56 with pockets 52 therebetween are positioned between the radiation shielding layer 40 and the outer layer 30. The insulation layer 50 adjacent to radiation shielding layer 40 may be referred to herein as an intermediate layer 60 but is typically the same material as the insulation layers 50 and/or the inner or outer layers 20, 30, respectively. Often, the intermediate layer 60 is the first layer of the insulation layers 50 and provides support for the radiation shielding layer 40. In one embodiment, the pockets 52 formed between reflective metal insulation layers are approximately ¼ through ¾ inches thick. In another embodiment, the pockets are approximately ¾ through 1½ inches thick. In yet another embodiment, one or more of the reflective metal insulation layers may be dimpled to allow additional structural integrity and/or to increase the reduction of thermal energy. Furthermore, the pocket 52 thickness may vary between layers. For example, the pocket 52 thickness between the first and second insulation layers may be ¼ inch while the pocket thickness between the second and third insulation layers may be ½ inch.

To determine the effectiveness of a close-packed array of radiation attenuating rods 42, such as shown in FIG. 3, testing was performed. A circular supporting two-end-plate structure was built and tungsten rods were inserted in a drilled pattern of close-packed holes. A light bulb was mounted in the interior center location and the unit was reassembled. Essentially no light was emitted from the unit because of the planned overlay of rods in the ray paths radiating outward from the light source. In a similar test, two 5 inch square thin metal boxes were constructed. In the first box, two layers of rods in close-packed configuration were inserted and in the second box, three overlapping layers of rods were placed. The box lids were screwed into place. The two boxes were then subjected to gamma radiation attenuation measurements using a calibrated radiation source at a Nuclear One facility. The measured attenuation result correlated directly with the calculated thickness of tungsten being presented to the radiation beam by the stacked layers of rods, which thereby indicated that essentially no shine, or gamma radiation leakage, was present. Such examples are easily applicable to a straight run of pipe wherein a thin sheet metal tube, preferably double-walled so that it includes an inner and an outer layer, but not necessarily, can be fitted around a pipe to be shielded. Rods can be inserted directly between the layers forming the tube or through slots or holes formed in the tube until the tube is filled with the desired number of layers of rods thereby forming a radiation shielding insulation apparatus of the present invention.

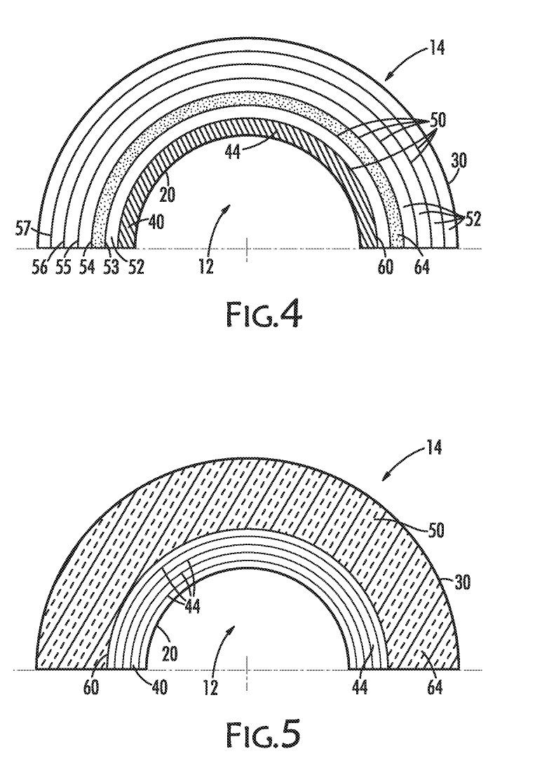

FIG. 4 discloses another embodiment of segment 14 of the apparatus 10 of the present invention incorporating an additional material as part of the insulation layers 50. For example, a diatomaceous earth layer 64 may be incorporated, which significantly reduces the temperature of the apparatus 10 from the inner layer 20 to the outer layer 30 because of the high insulation properties of diatomaceous earth. In the embodiment of FIG. 4, a combination of reflective metal insulation layers 60, 53, 54, 55, 56, 57 and a diatomaceous earth layer 64 are incorporated into the apparatus 10. Furthermore, the diatomaceous earth layer 64 may be inserted and sealed off in one of the pockets 52 formed between the reflective metal insulation layers 53 and 54 of the apparatus 10. In the embodiment of FIG. 4, the apparatus 10 includes an inner layer 20, a radiation shielding layer 40, an intermediate layer 60, a first reflective metal insulation layer 53 separated from the intermediate layer 60 by an air pocket 52, a diatomaceous earth layer 64, a second reflective metal insulation layer 54, and then three additional reflective metal insulation layers 55, 56, 57, followed by an outer layer 30, which are each separated by air pockets 52. In an alternative embodiment, such as shown in FIG. 5, the diatomaceous earth layer 64 may be directly adjacent to the intermediate layer 60, which is adjacent to the radiation shielding layer 40. Furthermore, the diatomaceous earth layer 64 may be directly adjacent to the outer layer 30. In the embodiment of FIG. 5, multiple tungsten sheets 44 are disclosed as the radiation shielding layer 40. Alternatively, in the embodiment of FIG. 4, a single tungsten sheet 44, having a greater thickness than disclosed in FIG. 5, is disclosed as the radiation shielding layer 40.

Diatomaceous earth is found in nature and is commonly in the form of a fine powder of silicon dioxide. In the present application, the power can be sealed off as discussed above between reflective metal insulation layers. Alternatively, it can be inserted into smaller cavities and then inserted within or between other insulation layers. The very small porosity of diatomaceous earth provides significant insulation properties and particularly low thermal diffusivity and thermal conductivity when compared with other materials, including the use of simple air pockets to provide thermal insulation. Diatomaceous earth is thermally stable and self-disperses in water. Further, it does not settle in water or cake and thereby avoids issues of clogging of water pumps and screens if the superheated water pipes in a nuclear facility catastrophically burst. Moreover, diatomaceous earth in fine powder form can fill almost any desired shaped pocket or reflective metal insulation design. Because of its significant thermal properties, less components, including reflective metal insulation layers, are needed within the radiation shielding insulation apparatus while providing even greater thermal insulation. Fewer components and layers often translates to less weight and therefore easier installation.

In an alternative embodiment, a fiberglass insulation layer, such as PCI's NUKON®, may be incorporated as an insulation layer. A fiberglass layer may be incorporated on the inside surface of the apparatus, such as adjacent the radiation emitting structure, as the inner layer of the apparatus, as the outer layer of the apparatus, and/or between the reflective metal insulation layers of the apparatus of the present invention. In one embodiment, a fiberglass insulation layer that is in the form of loose filled fiberglass contained within a fiberglass casing may be incorporated into the apparatus of the present invention.

Other insulation layers and materials having high insulation properties may be incorporated into the apparatus of the present invention without departing from the spirit and the scope of the present invention. For example, the insulation layers may contain known insulating materials, such as ceramic and/or glass based components, between the reflective metal insulation layers.

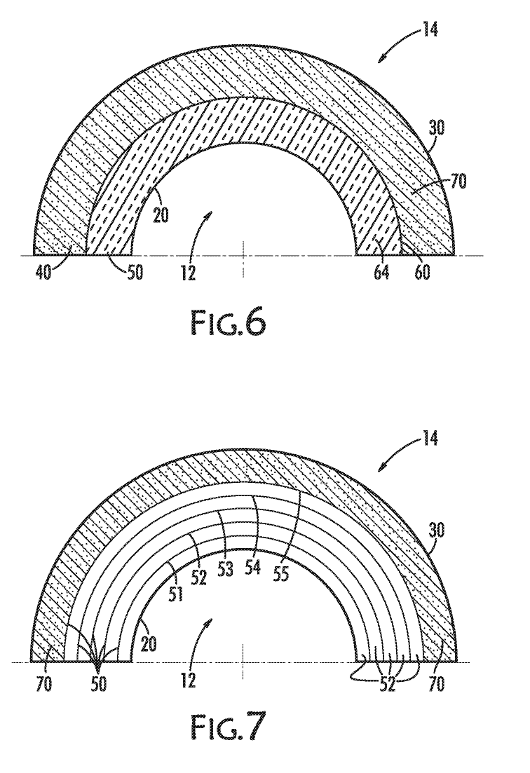

FIGS. 6 and 7 disclose additional embodiments of segments 14 of the apparatus 10 of the present invention. In these embodiments, the radiation shielding layer 40 includes a polymer radiation shield 70 as described above. Polymer radiation shields are very effective at shielding radiation but are not particularly high heat resistant because of the polymer component. Thus, as shown in FIGS. 6 and 7, one or more insulation layers 50 are preferably incorporated into the apparatus between the inner layer 20 and the radiation shielding layer 40 incorporating a polymer radiation shield 70. The embodiment of FIG. 6 discloses an inner layer 20, an insulation layer 50, such as diatomaceous earth layer 64, an intermediate layer 60 for fully encasing the diatomaceous earth layer 64, a radiation shielding layer 40 incorporating the polymer radiation shield 70, and an outer layer 30. In the embodiment of FIG. 6, the radiation attenuation material is dispersed within the polymer. The embodiment of FIG. 7 discloses a similar configuration but includes multiple reflective metal insulation layers 51, 52, 53, 54, 55 having spaced air pockets 52 between the inner layer 20 and the radiation shielding layer 40 incorporating the polymer radiation shield 70. Because diatomaceous earth is often a better thermal insulator and thereby allows for greater heat reduction within the apparatus than the reflective metal insulation layers, the embodiment of FIG. 6 may be preferred if the radiation emitting object has very high temperature. Alternatively, if the radiation emitting object does not emit very high temperatures, the reflective metal insulation layers as shown in FIG. 7 may be preferred. Moreover, a modified configuration of the embodiment of FIG. 7 may be used wherein one of the pockets 52 between the reflective metal insulation layers 51, 52, 53, 54, 55 is filled with a diatomaceous earth layer 64 or another insulating material to reduce thermal energy within the apparatus 10.

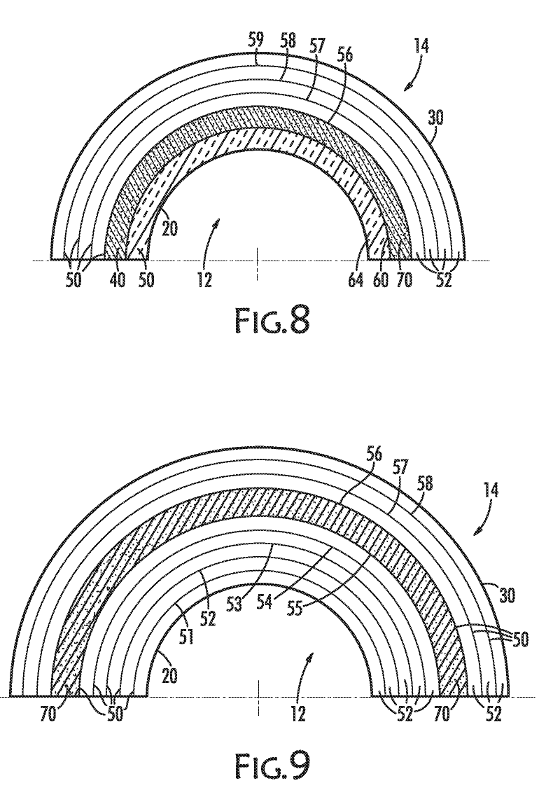

As shown in the embodiments of FIGS. 8 and 9, additional insulation layers 50, such as reflective metal insulation layers 56, 57, 58, 59, may be incorporated into the embodiments of FIGS. 6 and 7, respectively, between the radiation shielding layer 40 and the outer layer 30. Alternatively, a simple radiation shielding insulation apparatus, such as shown in FIG. 2, which includes an inner layer 20, an outer layer 30, and an intermediate radiation shielding layer 40, may form a cassette that is secured to the outside of existing radiation shielding devices that are already secured around radiation emitting piping systems. Latches, hinges, or other securing devices may be used to secure such cassette devices to each other and/or to the existing radiation shielding devices. Further, the radiation shielding layer 40 may be in the form of a tungsten sheet, multiple tungsten sheets, rows of staggered tungsten rods, and/or a polymer radiation shield.

While FIGS. 2-9 disclosed herein are referred to herein as a segment of the radiation shielding insulation apparatus, only a single segment may be needed to comprise the radiation shielding insulation apparatus of the present invention. Thus, the segments 14 of FIGS. 2-9 may disclose an entire apparatus 10 of the present invention. Further, the number and spacing of radiation metal insulation layers and/or pockets therebetween may be determined based upon the desired control of the heat loss to the ambient environment. The width of the layers shown in the embodiments of FIGS. 1-9 are for demonstrative purposes only and are not intended to be proportional to the actual layers of the apparatus and segments of the present invention.

As discussed herein, the radiation shielding insulation apparatus may be secured to a radiation emitting structure, such as a pipe running through a nuclear power plant facility to provide shielding against radiation and thermal insulation. Because of the harmful effects of radiation, it is most preferable that the apparatus is secured to the radiation emitting structure prior to or while the structure is not emitting radiation and off-line. Multiple radiation shielding insulation apparatuses may be secured to a structure and secured to each other. For example, because of the weight involved with the apparatuses, long pipe structures often require multiple apparatuses and segments when it is necessary to entirely encase such structures. Multiple apparatuses and segments may be joined together using connectors such as latches, by welding, or by incorporating a snap configuration. As discussed herein, it is preferred that all seams, joints, openings, holes, etc. that may expose individuals to harmful radiation be encased by the apparatus. Each apparatus and/or segment of an apparatus may contain all layers prior to being secured to the radiation emitting structure. Alternatively, certain layers of the apparatus and/or segments may be inserted after the other layers of the apparatus and/or segments are secured to the radiation emitting structure. For example, an apparatus having an inner layer, an outer layer, and at least one reflective metal insulation layer may be secured to the radiation emitting structure. After these portions are secured to the structure, the radiation shielding layers may be inserted. Such a method reduces the weight of the apparatus during installation. In one embodiment, the radiation shielding layer is inserted between the inner and outer layers. In an alternative embodiment, the radiation shielding layer is a polymer radiation shield that incorporates magnetic materials and is positioned around the outside of the outer layer. In an embodiment of the present invention, the radiation shielding layer includes a radiation attenuating material such as iron, tungsten, bismuth, lead, boron carbide, aluminum trihydrate, gadolinium oxide, and/or combinations thereof. In yet a further embodiment, multiple reflective metal insulation layers are incorporated and the radiation shielding material is inserted within a pocket or cassette formed between two reflective metal insulation layers. In such an embodiment, the radiation shielding material may be rods inserted between a reflective metal insulation layer cassette that may be inserted into a pocket of the apparatus. Alternatively, a puddy-based mixture incorporating a radiation shielding material such as tungsten or iron and a puddy-based material may be pumped into the pockets formed between the reflective metal insulation layers and then sealed off. In an embodiment of the invention, access panels may be incorporated into the apparatus of the present invention, which may be held in place and sealed from radiation emission with magnetic polymer radiation shield strips.

While various embodiments and examples of this invention have been described above, these descriptions are given for purposes of illustration and explanation, and not limitation. Variations, changes, modifications, and departures from the apparatuses and methods disclosed above may be adopted without departure from the spirit and scope of this invention. In fact, after reading the above description, it will be apparent to one skilled in the relevant art(s) how to implement the invention in alternative embodiments. Thus, the present invention should not be limited by any of the above described exemplary embodiments.

Further, the purpose of the Abstract is to enable the various Patent Offices and the public generally, and especially the scientists, engineers, and practitioners in the art who are not familiar with patent or legal terms or phraseology, to determine quickly from a cursory inspection the nature and essence of the technical disclosure of the application. The Abstract is not intended to be limiting as to the scope of the invention in any way.

1. A radiation shielding insulation apparatus, said apparatus comprising:
an inner layer;
a radiation shielding layer adjacent to said inner layer; and
an outer layer;
wherein said radiation shielding layer comprises tungsten.

2. The apparatus of claim 1, wherein said radiation shielding layer comprises a single tungsten sheet.

3. The apparatus of claim 2, wherein said tungsten sheet has a thickness of about 0.16 inches.

4. The apparatus of claim 1, wherein said radiation shielding layer comprises multiple tungsten sheets

5. The apparatus of claim 4, wherein each of said multiple tungsten sheets have a thickness of about 0.02 inches.

6. The apparatus of claim 5, wherein said multiple tungsten sheets include at least eight tungsten sheets.

7. The apparatus of claim 4, wherein at least one of said multiple tungsten sheets has a thickness of about 0.02 inches.

8. The apparatus of claim 1, wherein said radiation shielding layer comprises tungsten rods.

9. The apparatus of claim 8, wherein said radiation shielding layer comprises at least two rows of staggered tungsten rods.

10. The apparatus of claim 1, further comprising multiple insulation layers positioned between said radiation shielding layer and said outer layer.

11. The apparatus of claim 10, wherein said insulation layers are reflective metal insulation layers.

12. The apparatus of claim 10, wherein each of said multiple insulation layers are separated by pockets.

13. The apparatus of claim 12, wherein said pockets are between about ¼ inch to about 1¼ inch in thickness.

14. The apparatus of claim 11, wherein said reflective metal insulation layers are composed of stainless steel.

15. The apparatus of claim 1, wherein said inner layer and said outer layer are composed of stainless steel.

16. A radiation shielding insulation apparatus, said apparatus comprising:
an inner layer;
a radiation shielding layer adjacent to said inner layer;
an intermediate layer adjacent to said radiation shielding layer;
an insulation layer; and
an outer layer;
wherein said insulation layer is between said intermediate layer and said outer layer.

17. The apparatus of claim 16, wherein said inner layer, said outer layer, and said intermediate layer each comprise a reflective metal.

18. The apparatus of claim 17, wherein said reflective metal is stainless steel.

19. The apparatus of claim 16, wherein said insulation layer comprises diatomaceous earth.

20. The apparatus of claim 16, wherein said radiation shielding layer comprises tungsten.

21. The apparatus of claim 20, wherein said radiation shielding layer comprises a single tungsten sheet.

22. (canceled)

23. (canceled)

24. (canceled)

25. (canceled)

26. (canceled)

27. The apparatus of claim 20, wherein said radiation shielding layer comprises tungsten rods.

28. (canceled)

29. The apparatus of claim 16, further comprising multiple insulation layers positioned before said outer layer.

30. (canceled)

31. (canceled)

32. (canceled)

33. The apparatus of claim 29, wherein said multiple insulation layers include at least two reflective metal insulation layers and a diatomaceous earth layer.

34. A radiation shielding insulation apparatus, said apparatus comprising:
an inner layer;
an insulation layer;
an intermediate layer;
a radiation shielding layer; and
an outer layer;
wherein said insulation layer is positioned between said inner layer and said intermediate layer; and
wherein said radiation shielding layer is positioned between said intermediate layer and said outer layer.

35. (canceled)

36. The apparatus of claim 34, wherein said radiation shielding layer comprises a polymer radiation shield.

37. The apparatus of claim 36, wherein said insulation layer comprises diatomaceous earth.

38. The apparatus of claim 36, wherein said polymer radiation shield comprises a polymer and a radiation attenuating material.

39. The apparatus of claim 38, wherein said polymer radiation shield further comprises a magnetic material.

40. The radiation shield of claim 38, wherein the radiation attenuating material is chosen from the group consisting of iron, tungsten, bismuth, lead, boron carbide, aluminum trihydrate, and gadolinium oxide.

41. The radiation shield of claim 38, wherein the polymer comprises a liquid silicone rubber.

42. The radiation shield of claim 38, wherein the radiation attenuating material is dispersed within the polymer.

43. (canceled)

44. (canceled)

45. (canceled)

46. (canceled)

47. The apparatus of claim 34, further comprising an insulation layer positioned between said radiation shielding layer and said outer layer.

48. (canceled)

49. (canceled)

50. (canceled)

51. (canceled)

52. A method for shielding against radiation and providing thermal insulation, said method comprising the steps of:
providing an apparatus having an inner layer, an outer layer, and reflective metal insulation layers therebetween;
securing said apparatus to a structure for emitting radiation; and
securing a radiation shielding layer to said apparatus after said apparatus is secured to said structure for emitting radiation.

53. The method of claim 52 wherein said radiation shielding layer is secured between said inner layer and said outer layer.

54. The method of claim 53 wherein said radiation shielding material comprises a puddy mixture having a radiation shielding material, said method further comprising the steps of pumping said puddy mixture into said apparatus.

55. (canceled)

56. (canceled)

57. (canceled)

58. The method of claim 52 wherein said radiation shielding layer comprises tungsten sheets or rods secured within a cassette, said cassette is secured around the outside of said outer layer.
